(19) United States
(12) Patent Application Publication
(10) Pub. No.: US 2004/0148189 A1
(43) Pub. Date: Jul. 29, 2004

(54) Deposit return system for disposable packaging articles

(76) Inventor: Bouke Christiaan Stoffelsma, Monchengladbach (DE)

Correspondence Address: GREER, BURNS & CRAIN, 300 S WACKER DR, 25TH FLOOR, CHICAGO, IL, 60606, US

(21) Appl. No.: 10/697,389

(22) Filed: Oct. 30, 2003

Related U.S. Application Data
(63) Continuation of application No. PCT/DE02/01566, filed on Apr. 30, 2002.

(30) Foreign Application Priority Data
Apr. 30, 2001 (EP) 01110633.3

(51) Int. Cl. G06F 17/60

(52) U.S. Cl. 705/1; 705/405

(57) ABSTRACT

The invention concerns a computer-managed deposit system for articles, in particular for disposable packaging articles, a return device for articles having a deposit thereon, in particular for disposable packaging articles, an originality seal for identifying articles, in particular disposable packaging articles, and a detection apparatus for use with the deposit system. To prevent fraud caused by multiple returns in accordance with the invention there is proposed a method having the following method steps: associating the article with a unique identification from a plurality of identifications managed in a database (linkage), associating the identification from the database with a deposit value, using the article in at least one intermediate step, detecting the identification of the article and identifying the article on the basis of the identification, and cancelling the linkage of the identification in the database when removing the deposit from the article.

### CROSS-REFERENCE

This application is a continuation of International PCT Application No. PCT/DE02/01566, filed Apr. 30, 2002.

### SPECIFICATION

The patent application concerns a computer-managed deposit system for articles, in particular for disposable packaging articles, a return device for articles having a deposit thereon, in particular for disposable packaging articles, an originality seal for identifying articles, in particular disposable packaging articles, and a detection apparatus for use with the deposit system.

### BACKGROUND OF THE INVENTION

Deposit systems for reusable packaging articles such as glass or PET bottles are in existence in Germany and other countries. In 1991 in Germany the legislators issued a Packaging Regulation (PackReg) which is intended to guarantee a minimum quota of 72% for the reusable packaging articles having a deposit thereon. That legally prescribed level has repeatedly not been reached since 1997. The PackReg provides that, if the minimum quota is not reached repeatedly, a deposit is also to be introduced for disposable packaging articles.

Previous deposit return systems form a closed circuit between the packaging filler, stores and the consumer. The deposit is a constituent part of the packaging article and can thus also change owner with the packaging article. Disposable packaging articles involve the problem that the packaging articles can no longer be used in a direct circuit as they are not used afresh by the packaging filler. Instead, the packaging articles with a deposit thereon are sent for disposal thereof. One way of guaranteeing this is for the disposable packaging articles which are taken back by the stores to be destroyed. That necessitates complex automatic systems involving different destruction mechanisms. Those automatic apparatuses are to be set up at large shopping centers and permit return.

Previous approaches to the aspect of implementing a deposit for disposable packaging articles are based on the notion of using tamper-proof identifications, for example in the form of holograms, that is to say providing copy protection for the deposit seal and destroying the returned packaging articles. Those systems are not only complicated and expensive but they are also susceptible to fraud.

### SUMMARY OF THE INVENTION

The object of the present invention is to provide a simple and cost-effective deposit return system and the corresponding means for the implementation thereof.

In accordance with the invention that object is attained by a method comprising the following method steps: associating the article with a clear identification from a plurality of identifications managed in a database (linkage), associating the identification from the database with a deposit value, using the article in at least one intermediate step, detecting the identification of the article and identifying the article on the basis of the identification, and cancelling the linkage of the identification in the database upon return of the deposit on the article.

Herein the term identification is used to denote any manner of clearly indicating the disposable packaging article, for example by a deposit number. The deposit number can be in numerical, alphanumeric or graphic format. Combinations of the representation formats are also possible.

The deposit number is preferably arranged on the article on which the deposit is to be paid, wherein in particular direct application in the manner of integration into the surface appears desirable as that physically guarantees the connection of the article to the deposit number. In accordance with the system articles and in particular packaging articles are identified in the packaging filling procedure, by the application of a clear deposit number. That deposit number is stored in a deposit database with the associated deposit value and optionally with more extensive information.

Alternatively the deposit number can be subsequently printed on or can be applied to a sticker which can be joined to the article. It is however also possible for the deposit number to be applied on a separate carrier in the manner of a token.

Advantageously the identification of the article that is to say the deposit number applied thereto, is such that it is tamper-proof in order in that way to avoid abuse.

Management of the identifications and the association thereof with articles and deposit values respectively is implemented by a deposit database in the deposit system according to the invention. The database can be in the form of a central database or in the form of a distributed or segmented database. That manner of managing the identifications is particularly advantageous for the reason that, in an online procedure and thus as close to real time as possible, it permits direct checking on an asserted claim on the part of a person returning the article with a deposit thereon, to be given the monetary value corresponding to the deposit value.

By way of example a deposit is placed on a disposable packaging article in the packaging filler procedure and then, provided with the deposit, can pass through one or more stages in the course of trade therewith. When the disposable packaging article is given back the deposit thereon is returned. If the deposit number is applied to a separate carrier in the manner of a token, it is necessary to ensure when the article is returned that, upon return of the token, the packaging article corresponding to that group of packaging articles is also surrendered. In order to ensure that the prescribed or desired disposal process chain is followed for disposal of the disposable packaging articles, it can be provided in a further development that, when passing through the individual process steps, amounts of the deposit are credited to the operators of the recycling or disposal installations.

In the normal case the deposit numbers are called up from the deposit database before they are applied to the disposable packaging article in order to prevent possible multiple deposit implementation (the provision of a plurality of packaging articles with the same deposit number). Alternatively it is possible to allocate to the packaging filling operators sets of numbers which are determined by the deposit database and which are reserved for them, from the reservoir of deposit numbers.

In addition however the use of databases also permits other functions and the initiation of additional operating procedures upon the surrender of an article with a deposit thereon. Firstly this can involve a refund of the amount of money corresponding to the deposit value, to the person surrendering the article. In that case it is particularly advantageous to implement that refund as a cashless transaction, for example by credit to an account, a money card or the like as that means that there is no need to keep amounts of cash. In this connection however a cashless process can be a payment in kind, which is virtually convertible, for the person surrendering the packaging article. Thus it is also possible to envisage a credit to an organisation other than an account-holding bank, that is to say for example a telephone connection or an anonymous credit card. In regard to a credit card as just mentioned it may be provided for example that it is issued by appropriate organisations exclusively for the purposes of crediting deposit values in a method according to the invention.

It is particularly advantageous in this connection if, upon delivery of the article, additional data which can be associated with the person are recorded and processed. In this case the procedure involves so-to-speak personalisation of the credit amount to be paid out for the deposit value of the surrendered article, in regard to which the person can decide on the use of the amount to his or her benefit.

In accordance with the invention the identification of the article can be linked to further items of information. Thus it is possible inter alia for the identification, besides the deposit number, to be provided for example with a symbol expressing the deposit value, in particular a number, or in addition for an expiry date to be applied to the identification, which makes it clear to a consumer the date by which payment of the monetary value corresponding to the deposit is guaranteed on the part of the article-disposal organisation.

In the deposit return system according to the invention, it is provided that the article remains undamaged upon surrender, and destruction of the packaging articles is therefore not necessarily to occur. Electronic invalidation of the packaging articles with a deposit thereon replaces mechanical destruction of the deposit item. As the concept manages without the expensive procedure of destroying the packaging article when it is returned, the system, in comparison with the estimates published by the Ministry of the Environment, reduces the one-off investment figures of around 1 billion Euros to 141 million Euros. That cost saving is substantially implemented by the inexpensive and small invalidation units involved. Invalidation units can be used as mobile devices at kiosks, filling stations and naturally also quickly and easily in stores. There, the deposits can be returned on packaging articles and the articles can be disposed of, without any problem.

The return of disposable packaging articles can be effected at all existing acceptance locations for reusable packaging articles. Instead of some thousand central automatic installations, this involves a system which permits the return of the packaging articles at a hundred thousand kiosks and supermarkets over a widespread area.

The object of the invention is further attained by a return device for articles bearing a deposit, in particular for disposable packaging articles, which is provided for example for use with the above-indicated deposit system and has a receiving device and at least one detection apparatus. The detection apparatus clearly detects and identifies an article arranged in the receiving device, on the basis of an identification on the article. Therefore, arranged at the receiving device of the return device according to the invention are means for detecting an article intended to be returned so that the article can be detected and identified and after optionally possible release can be passed along for disposal.

In an advantageous development of the return device provided thereat is a deposit-removal device, by means of which the deposit can be removed from the article in a deposit-removal operation and a deposit value associated with the article can be passed to a settlement procedure. After detection and identification in the return device the article to be taken back subsequently undergoes a devaluation procedure in terms of its deposit by means of the deposit-removal device, in such a fashion that it loses its deposit value. Further use of that deposit value then takes place in a settlement procedure of any appropriate configuration, which for example is effected cashlessly in the course of a clearing process.

That can be implemented in a particularly advantageous fashion if the deposit-removal device, during the deposit-removal operation, is at least temporarily connected to at least one database in which the linkage of the identification is cancelled and in that way further use thereof is prevented. For that purpose, using an ordinary communication path such as for example a line-supported or radio-supported telecommunication path, the deposit-removal device forms a connection to a database which manages the associations of articles and identifications. Accordingly it is further advantageous if the deposit-removal device has communication means, by way of which it makes a connection to a data processing apparatus with access to a database.

Establishment of the connection to the database can in that respect be a one-off matter in the sense that the connection exists continuously once it has been formed, but it can also only be made at certain moments in time or in response to certain requirements. It is further possible to envisage in this connection that the deposit-removal device is provided with a local memory which for example then locally provides its own sub-database, for example with a given reserved set of identifications, and adaptation takes place by way of a connection to a further database only at fixed moments in time. In addition the above-mentioned local memory could also be used to provide a number of identifications which were used last, so that interrogation and testing thereof takes place even more quickly than by the interrogation of a remotely provided database.

In the deposit-removal operation, in the above-mentioned database, the linkage is cancelled for example by the preferably clear identification being taken out of the database. In addition it is also possible to envisage that identification only remaining in the database with a time-limited or definite blocking note. Cancellation of the linkage between identification, article and deposit value at any event provides that a possibly forged, identical identification could not be used once again in that manner and in that case the return device refuses to issue the deposit value so that this therefore prevents multiple use of the identification. It will be appreciated that the above-mentioned term telecommunication path also means any computer connection between two data processing installations. Thus for example the return station or the deposit-removal device thereof could communicate by way of a radio standard, such as for example Wireless LAN, with a so-called access point which then takes up the connection to the computer holding the database. It is also possible to envisage that the deposit-removal device itself functions as that access point for such deposit-removal devices which only have a radio interface provided for that kind of communication.

The communication means arranged at the deposit-removal device further also relate to means with which a user, whether the user is a person returning an article or a maintenance engineer, can identify himself in relation to the deposit-removal device. That can be done for example by the use of a code card carrying given items of information, for which a reading unit can be provided at the deposit-removal device. For that purpose the above-mentioned code card can contain any items of information which can be used for the system, thus for example the name of the user or an account connection. It is not necessary in that respect for the information to be personalised for it is also possible in that respect to consider an anonymised or provisional card with which person-related data are associated only at a later moment in time or also not at all, thus for example the code card can be envisaged in the form of a card associated with any payback system. For a maintenance engineer it is possible to envisage code cards containing either data which can be associated with the engineer or which can be associated with the return device to be maintained.

It is desirable in the sense of ease of handleability if the receiving device has at least one guide means, in particular a guide rail, for positioning of the inserted article. The arrangement of a guide means is appropriate for the reason that it permits a user of the receiving device to introduce the article to be taken back, in a simple and reliable fashion, and in addition permits the detection apparatus to quickly and reliably detect and identify the article and its identification. In addition the guide means can also be adapted to preselect the articles to be taken back, in such a way that it only permits the feed of articles of a given geometry, which can be desirable in the sense of providing for space-saving or pre-selected storage. As an additional aid it is possible for example to provide on the guide means an abutment which presets for the user a depth of insertion of the article for optimum detection thereof.

There is also the possibility, if the articles to be received are to be classified on the basis of their weight, to provide at the guide means a weighing mechanism which transmits the weight information that it ascertains.

In a development of the return device according to the invention, the receiving device can have a closure mechanism which is integrated or which can be arranged separately thereon. That mechanism can be for example in the nature of an automatic or manually actuable closure member which can be pivoted into a position in front of the opening of the receiving device. On the one hand, by means of that closure mechanism it is possible to prevent abuse of the return device if the return device should be used improperly unintentionally or intentionally, for example by the introduction of articles for which it is not intended, while on the other hand this affords a possible way of taking the return device out of further use when a receiving container provided for that purpose is in a full condition, until it can be emptied.

In order to be able to provide for proper use of the return device and use of the deposit system, in accordance with the invention provided at the detection apparatus are detection means in the form of a light barrier arrangement and/or a scanner and/or a camera. In this respect the detection means serves in the manner of a scanner for detecting and identifying the article itself introduced into the receiving means, for example on the basis of its identification or however also on the basis of its geometry. If the scanner detects the identification of the article, that identification can be subjected to further processing by the deposit-removal device while in the event of unsuccessful identification further steps in the deposit method can be refused.

A detection means designed in the form of a light barrier arrangement can be used on the return device in such a way that the operations related to the deposit-removal procedure by the deposit-removal device can be initiated only when the article has passed a point or a plane of the return device, which makes it impossible for it to be removed again from the return device. That ensures that the article from which the deposit is to be removed is also actually passed for disposal and the deposit which is to be paid back in that respect is requested with every justification on the part of the person returning the article. Optionally it would also be possible to consider for example an arrangement of reflectors in the viewing window of the scanner instead of a light barrier arrangement. Finally it is also possible to use a camera as the detection means, for example instead of the scanner, in which case the signal recorded on the part of the camera can also be optically transmitted and can serve in that way for the communication of information.

For user-friendly user guidance it is advantageous to arrange at the return device for providing information for a user a display device, in particular a viewing window and/or an optical and/or acoustic signalling means and/or a display. It is possible in that way to impart certain items of information to the user who is returning an article which has a deposit thereon, and thus to influence the behaviour of the user in the subsequent steps. Thus for example the signalling means which can be for example light emitting diodes or a simple loudspeaker can be provided to display to the user, by affording various signals, whether he has correctly arranged the article in the receiving device. A viewing window would give the user the option to observe the article which is disposed in the receiving device, and if necessary re-align it. The same thing could also be afforded by a display which shows a signal transmitted to the user by the above-mentioned camera. If the display for example is in the form of a touchsensitive screen, that gives the user a large number of further options in terms of interaction. In particular it is then possible with such a display to request items of information which are to be inputted directly by the user, for example for further use of the deposit amount to be paid. In addition the display can be used for example for communicating information to maintenance personnel on site, for example in regard to the filling condition, cleanliness, power supply or maintenance intervals.

For integration of a return device according to the invention into already existing collecting apparatuses, it is particularly advantageous if the return device can be arranged at a collecting container for the articles which are to be taken back. It is possible in that way for practically all collecting containers which are used at the present time and in future for receiving articles, for example the containers which are set up at many locations, to be equipped for use with the return device. For that purpose the return device only has to be arranged on the collecting container or introduced with regions intended for that purpose into the receiving opening of the corresponding collecting container and for example fixed and secured by means of a clamp and a lock. In that respect, for the various different forms of container, it is additionally possible to provide a coupling portion which is to be arranged for example in the form of a sleeve between the return device and the collecting container. To deal with a possible period when the return device is not in use, the collecting container can continue to be used as an ordinary refuse container, in spite of the return device remaining in place.

For operation of the return device it is provided that it has a mains-independent or mains-supported voltage supply. Depending on the respective local factors involved therefore the return device can be operated at locations at which a voltage supply is available by a mains system, but it is then also possible for the return device to be operated in a power-autonomous mode over a certain period of time, for example by the use of accumulators. That period of time can be additionally prolonged by the provision of a power-saving operating mode when the device is not in use.

As already mentioned hereinbefore, for influencing the procedures of the return device, it is desirable if it has a user interface which permits a user to interact with the return device, in particular permitting the implementation of a settlement process for redeeming the deposit value. In that respect the form of the interaction can go from simply starting up the return device, for example by inserting a code card into a card reader, to a complex transaction in respect of the deposit value or a plurality of deposit values on a settlement system of any kind.

The object of the invention is further attained by an originality seal for identifying the article for a computer-managed deposit system. The seal is fixed on the article by means of an adhesive layer, and it has a printable carrier layer which is arranged on the adhesive layer and which can be provided with an identification associated with the article. In that case the carrier layer is at least partially covered over by the seal layer which can only be detached from the carrier layer with accompanying destruction. Accordingly the originality seal according to the invention comprises a multi-layer sticker for the article to be identified, for example in the manner of a label, which can be applied to a location provided for that purpose on the article. An adhesive layer is arranged between a carrier layer which carries information and which was processed by a printing procedure for applying the information, and the article, to provide for adhesion of the originality seal. On the side of the originality seal which is towards a viewer, the seal is protected by a seal layer which at least partially covers the carrier layer. That seal layer serves on the one hand for mechanically protecting the identification, while on the other hand it can be so designed that only the detachment thereof makes it in any way possible to remove the deposit on the article by exposing the identification. In that situation the seal layer is destroyed.

In an advantageous development the adhesive layer is a non-detachable adhesive. That affords a non-releasable bond between the article and the identification on the carrier layer, and that bond can only be separated again by destroying at least the identification, with the result that the corresponding deposit value can no longer be redeemed.

In a further configuration the carrier layer of the originality seal has at least one incision. That incision has the result that, in the event of an attempt to detach the originality seal from the adhesive layer, the latter rips or tears in half along the incision so that further use is not possible.

In a particularly preferred feature the identification of an originality seal according to the invention includes a two-dimensional bar code. The use of such a code is already desirable for the simple reason that, in that way, while involving a relatively small amount of space, this affords a whole host of possible identifications which can be of the order of magnitude of about 10¹⁸ or even greater. In addition this form of coding presents itself as it is highly suitable for including in the code additional items of information which can relate to the article, its material, producer or the like. In addition this form of coding also facilitates the settlement of deposit values. In addition, with this form of code, it is also easily possible to produce and associate sets of numbers for any use. They can for example in turn relate to certain kinds of goods or also marketing areas or the like.

Furthermore, in a development, the seal layer can be provided with an additional visual feature. This for example may involve a colored marking which, as part of the seal layer, in turn covers a part of the identification of the article. In the event of damage to or removal of that visual feature a user is immediately advised, due to the absence of the feature, that the identification has possibly already been subjected to a deposit-removal operation so that that indication tells him to refrain from a purchase of that article, in respect of which he will possibly no longer receive a recompense value for the deposit value upon returning the article.

Among the many possible options in regard to the configuration of the seal layer it is particularly preferably made from an adhesive, a wax or a rubber coating, which can all be easily removed to prepare for the deposit-removal operation.

Finally the object of the invention is also attained by a detection unit for automatically detecting an identification on an article having a deposit thereon, which is intended in particular for use with the described deposit system. The detection unit includes in particular a scanner for detecting the identification of a disposable packaging article and has detection means for reading off the identification, and means which ensure that detection of the identification takes place only when the packaging article is emptied. By virtue of the use of a small portable hand unit in the form of a scanner, it is in this case a matter for the organisation receiving the articles which are to be given back, to decide how the appropriate storage thereof is to be implemented, while the procedures involved with the deposit-removal operation can be effected by the detection unit. A user can use the components of this modular system separately or together.

A central problem in terms of practical implementation of the method according to the invention are the transmission times and transmission costs related thereto for connecting the scanner to a central data processing apparatus. Preferably for that reason processing is effected batch-wise in order to reduce the transaction costs. Thus a plurality of labels can be detected by a store owner for the deposit-removal operation and collected in one data file. That file is transmitted to the central processing apparatus upon exceeding a given size, when therefore a given number of labels has been detected. That procedure would present itself for example in relation to a sales or collection stage in a middleman situation.

In an alternative configuration it can be provided that upon the purchase of a disposable packaging article the trader issues a voucher which can be redeemed against the amount of the deposit upon return of the packaging article and in the deposit-removal procedure. The central computer credits the amount to the trader, and that can also be effected in a batch process. Non-redeemed vouchers are therefore to the benefit of the trader, which makes this arrangement particularly attractive to the trader.

By virtue of the coupling of given automatic apparatuses to specific traders, the central computer and the system knows what sums the store has paid out. The central computer can thus implement a central remittance so that it is not necessary to book in every voucher.

The invention further concerns a detection apparatus for automatically detecting a deposit mark on a packaging article or the like. In particular it concerns a scanner for detecting the deposit mark on a disposable packaging article. Preferably the scanner is in the form of a hand scanner.

Known detection apparatuses, in particular scanners, already permit relatively simple detection of the deposit marks for removal of the deposit on a packaging article when it is returned. In terms of implementing the method according to the invention however the problem also arises that a purchaser may attempt under some circumstances to directly remove the deposit from a packaging article before it is emptied, in order to obtain the deposit redemption value.

The invention is intended to provide a further development in a detection apparatus of the general kind set forth, in such a way that the detection of the label can take place only when the packaging article has actually been emptied. As packaging articles are made from various materials such as polyethylene (PET), metal sheet, aluminum, multi-component materials or the like, the choice of the means to ensure that fundamentally depends on the material of the packaging article.

For relatively rigid packaging articles such as cans, canisters or the like the detection apparatus can be provided with a receiving device for the packaging articles, which is so dimensioned that the packaging article can be received therein only in the emptied condition. That configuration is based on the notion that the packaging article in the closed condition, due to the medium contained therein, basically cannot be compressed. The rigid packaging article in contrast can be at least slightly compressed when it has been opened.

The receiving device can be of a substantially bridge-shaped configuration, with a free space extending between two limbs. The internal distance between the front ends of the limbs is slightly smaller than the outside diameter of the packaging article to be detected. As the reading unit is arranged substantially at the apex, that is to say the highest point of the bridge-shaped opening, detection can take place only when the label is disposed in the immediate region of the reading unit. That however in turn is only possible when the packaging article has been compressed in order to insert it into the receiving device.

In a further development it can be provided that the internal distance between the limbs of the receiving device is adjustable so that it can be used for various packaging articles involving different dimensions.

In another structure a loop or the like can be provided on the detection apparatus, the loop being so dimensioned that it is possible to read off the deposit mark only when the loop is introduced into the opening of the packaging article from which the deposit value is to be removed. The loop thus prevents the closed packaging article from being arranged in front of the reading unit of the detection apparatus. Reading can be effected only when the loop has been inserted into the opening of the packaging article. It will be appreciated that the packaging article will then also be empty. In order to prevent liquid from still nonetheless being present in the packaging article, the free end of the loop can additionally be provided with a moisture sensor.

The loop can be for example of a substantially U-shaped configuration which firstly extends laterally from the fixing point to the detection apparatus away therefrom and after a 180° curvature leads back in front of the reading unit of the detection apparatus. The loop can be retro-fitted to existing detection apparatuses such as for example a hand scanner.

For the purposes of adapting the loop to different packaging article sizes, it can be provided that the loop is adjustable in respect of its size. For example it can be telescopic in order to effect adaptation in respect of its size for detecting cans and bottles.

An alternative configuration provides that the detection apparatus is provided with a bar which in the detection operation passes into the packaging article. As in the case of the above-described structures this one is also based on the idea that the operation of reading the label is only possible in the immediate region of the detection unit.

Another structure provides that the detection apparatus is provided with sound generators for applying a sound pulse to the packaging article and sound detection means for detecting the sound pulse. The sound generator can be for example a simple loudspeaker. Preferably however lithotriptors are used, which produce a short, explosive sound wave. The sound detection means is preferably in the form of a microphone. The microphone detects the signal emitted by the sound-generating means. As the signal is propagated at different speeds in liquids than in air, it is possible to ascertain by means of the transit time delay or spectral analysis with decision criteria whether the packaging article is full or empty. Spectral analysis of the echo gives information about the filling condition of the packaging article.

### BRIEF DESCRIPTION OF THE DRAWINGS

The deposit system according to the invention and the means for carrying it into effect are described by way of example with reference to the Figures in which:

FIG. 1 shows the basic system procedure in the form of the circuit of a deposit-bearing article in the form of a disposable packaging article,

FIG. 2 shows the diagram of possible forms of attack on deposit systems and measures for fending them off,

FIG. 3 shows graphic forms of representation of identifications, for example deposit numbers,

FIG. 4 shows the structure of an originality seal according to the invention,

FIG. 5 shows the principle of deposit redemption,

FIG. 6 shows a mobile hand scanner for use with a deposit system,

FIG. 7 shows a hand scanner with a receiving device according to the invention,

FIG. 8 shows a side view of a hand scanner with a loop according to the invention,

FIG. 9 shows a side view of an alternative embodiment of a hand scanner which operates by means of sound and resonance,

FIG. 10 shows a plan view of the side, towards the user, of an embodiment of the return device, and

FIG. 11 shows a view in cross-section through the view of the return device of FIG. 10 along line X-X.

### DETAILED DESCRIPTION OF THE PREFERRED EMBODIMENTS

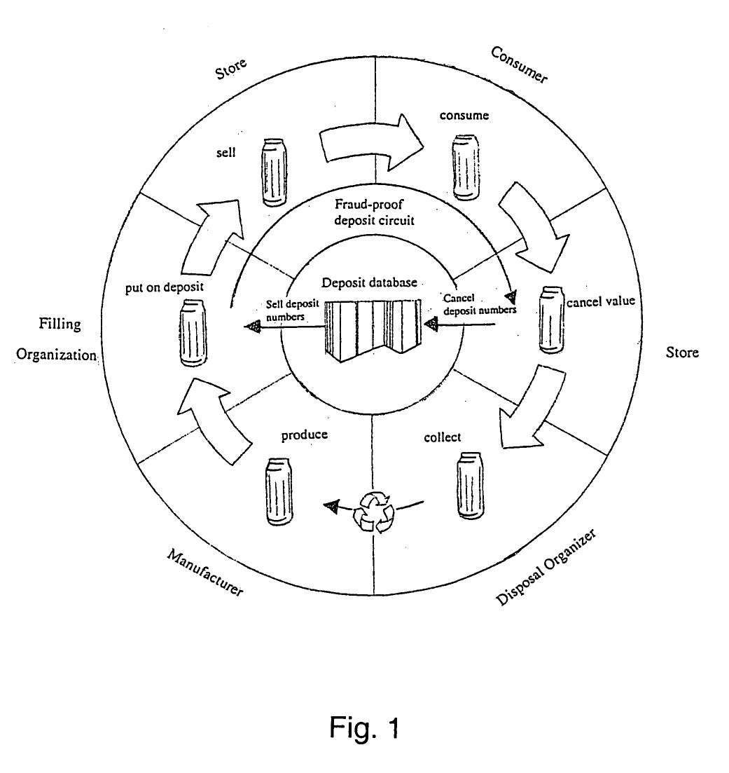

The basic system configuration with the deposit and material circuits is shown in FIG. 1. Accordingly it is possible to identify two circuits, the material circuit and the deposit circuit.

The material circuit is shown in FIG. 1 by wide arrows. The manufacturer produces packaging articles which during the filling operation are labelled with the deposit numbers obtained by the filling organisation as identifications. The products identified in that way are sold including the deposit costs to the stores. They sell on the products including deposit costs to the consumer. After consumption the consumer brings the empty packaging articles back to the store. The packaging articles returned at the store, after the deposit value has been removed therefrom, are prepared for the disposal organisation. No particular demands are made on the preparation procedure such as for example previous destruction or theft-proofing. The packaging articles can thus be prepared in containers, bags or drums to be taken away by the disposal organisation.

Recyclable materials, after recycling thereof, can be sold to the manufacturer as raw material for the production of fresh packaging articles.

The deposit circuit is identified in FIG. 1 by thin arrows. For each of its packaging articles, the filling organisation obtains an individual deposit number which it receives from the deposit database. The packaging article has a deposit placed thereon by virtue of applying the deposit number to the packaging article, as the deposit value of that packaging article is noted in the deposit database. The deposit value remains on the packaging article through all trading stages until the consumer returns the packaging article to the store. Upon return the deposit number is taken out of the deposit database in an online procedure and the deposit value is credited to the consumer. From that moment in time the applied deposit number is valueless and cannot be returned a second time. Thus the packaging articles can be prepared for collection, in open containers. The packaging articles, after removal of the deposit value therefrom, only involve value as raw material.

The system affords the following advantages:

The use of electronic value-removal apparatuses permits separation of the two circuits and makes it unnecessary to set up mechanical automatic equipment for destroying the packaging article.

The electronic value-removal apparatuses can be produced at considerably lower cost. They permit widespread use by virtue of their low costs and small dimensions. With portable value-removal apparatuses, packaging articles can be taken back at kiosks, restaurants, filling stations and the store where they are sold.

The use of individual deposit numbers means that the deposit can be selected as desired in terms of amount and currency. This means that the system can be used on an international scale.

The deposit system according to the invention is independent of packaging article shapes and sizes as well as the changes therein, in contrast to automatic return apparatuses which can recognise, process and sort only a limited number of types of packaging.

Security against abuse is a central problem for deposit systems. The deposit system according to the invention withstands inter alia the following attack scenarios:

a) Repeatedly bringing in packaging articles

Scenario: by repeatedly bringing in packaging articles for which the deposit has already been paid out, it is possible to obtain deposit payments by underhand means.

Measure: the use of clear deposit numbers and online checking in the deposit database upon return makes it possible to detect whether packaging articles from which value has already been taken are brought in again, at all return stations. That prevents repeated return of the deposit.

b) Bringing in packaging articles which are foreign to the system.

Scenario: bringing in packaging articles which are foreign to the system and for which no deposit was paid make it possible to obtain deposit payments by underhand means.

In the case of the deposit methods hitherto on the market for reusable packaging articles the deposit is 0.15 Euro for each packaging article. The production costs of the packaging articles however are about 0.17 Euro per packaging article. The deposit value is therefore less than the packaging article production price.

Due to the relatively high deposit value (for example 0.25 Euro to 0.50 Euro) planned for the disposable packaging articles, there is a high level of motivation to defraud the deposit system as the deposit value of the packaging article is higher than the production costs. The risk of fraud is considerable in particular in the case of cans involving production costs of a few cents of a Euro.

Measure: the unique deposit number in the deposit circuit excludes this attack. When the packaging article is returned, an online check is made in the deposit database to ascertain whether a deposit was previously paid in for that packaging article and that deposit has not yet been paid out. This therefore excludes packaging articles which are foreign to the system and which do not have a deposit number from being returned against redemption of a deposit.

c) Premature removal of value from packaging articles

Scenario 1: by virtue of removing value from packaging articles prior to sale to the consumer, for example by the store, the deposit can already have been removed from the packaging article when the article is sold. That means that the consumer is cheated by the amount of the deposit as, when the article is returned, the value-removal operation which has already been effected is found and the consumer does not get his deposit back.

Measure: this fraud situation can basically be detected by the deposit database as the deposit database automatically registers multiple return. If the consumer insists that he had paid a deposit, a process is initiated which transfers the case to fraud management (fraud detection: uncovering simple or organised service abuse). The purchase and address data of the consumer are taken down and the packaging articles kept separately. In the case of systematic fraud the defrauder can be identified in that way.

In order further to limit the fraud options in a further development the deposit numbers applied to the packaging articles are concealed (sealed). It is only when the concealing covering is rubbed or scratched off that it is possible to read the deposit number and thus pay out the deposit. A packaging article from which value has been prematurely removed can thereby be recognised by the consumer, by virtue of the uncovered deposit number.

Scenario 2: by virtue of value being removed from full packaging articles directly after purchase by the consumer the deposit is redeemed and paid back. Thus the customer has acquired a packaging article without deposit and must no longer return the packaging article.

Measure: in this fraud situation the sales person is circumventing the Packaging Regulations and is thus perpetrating a violation. To remove the deposit a deposit scanner and an agreement with the operator of the deposit database is required. In consideration of a contractual agreement a sale of products from which value has been removed can be linked to corresponding sanctions. In the case of larger (unsupervised) return stations, removal of the deposit can be linked to physical monitoring of the return of a packaging article.

d) Duplication of the deposit identifications

Scenario: as the deposit identification represents the actual value of the deposit manufacturers, filling organisations, stores and consumers could produce duplicates of the deposit numbers and thus try to obtain the deposit by underhand means.

Measure: the unique deposit number and the online checking thereof upon surrender excludes multiple payment of deposits for duplicated deposit identifications. The system recognises the fraud and notifies the attempted multiple surrenders to the fraud management department.

e) Guessing deposit numbers

Scenario: manufacturers, filling organisations, stores and consumers could try themselves to produce valid deposit numbers and to achieve a payback without actually paying a deposit.

Measure: by choosing a large set of numbers successfully guessing deposit numbers is in actual fact impossible. For example only one out of 10 millions of possible numbers is valid.

f) Altering deposit numbers

Scenario: manufacturers, filling organisations, stores and consumers can try to alter the existing deposit numbers and thus make it impossible for the deposit to be paid out.

Measure: the alteration to deposit numbers is detected upon online return as here too the large set of numbers detects the altered deposit numbers as being invalid. That then corresponds to guessing deposit numbers.

g) Modification of the return system

Scenario: if cashless credits are provided for paying back a deposit, stores could accept packaging articles from the consumer and by manipulation prevent cashless credits. A later genuine transaction would then be effected with the packaging articles, to their own benefit.

Measure: as in that case the store defrauds not the deposit system but the consumer, it is highly probable that the consumer notes this fraud. Complaints in this respect from consumers are passed to the fraud management team. It is also possible that, in each cashless deposit return, a receipt document is printed for the customer. If accounting for the deposit payback is effected exclusively on a cashless basis, the transaction can possibly be attributed to the storekeeper to his own advantage.

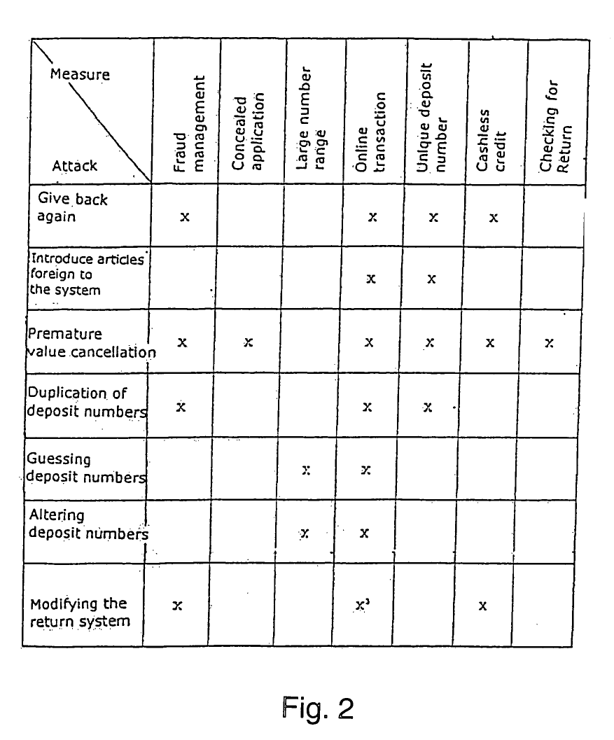

FIG. 2 compares once again the previously identified attacks and measures for preventing them.

The representation of the possible forms of attack shows that all attacks can be detected. That affords the possibility of pursuing these in the context of fraud management.

The transparency of the attacks permits any scaling of the prosecution of fraud. The uses necessary for that purpose for the security of the system can thus be adapted to the real security needs of the system.

As the packaging articles are not destroyed and a deposit is only paid out once in each case, evidence can be certainly secured in suspicious circumstances.

The system participants consisting of filling organisations and stores are identified in relation to the central system. Systematic manipulation involves a considerable risk of being detected and convicted.

Without electronic implementation by way of an online database fraud is possible to an unknown level and due to the system involved cannot be detected. The advantage of the online system therefore lies not only in the possible prevention of attacks but in particular in the detection thereof.

There are various alternative implementations in regard to the deposit identification. It is assumed that in general the deposit number is already applied to the disposable packaging articles in the packaging filling process. The identification with the deposit does not necessarily have to be implemented upon production. It is also possible to provide for later or earlier application of the deposit number, for example on imported goods in the retail trade.

In accordance with the system each deposit number must be unique and each packaging article receives its unmistakably associated deposit number. Production or issue of the deposit numbers is centrally managed and controlled in order to exclude manipulation procedures and forgeries.

The deposit numbering can be designed for example for 100 billions (10¹¹) of packaging articles which can be simultaneously processed with the system. This involves the packaging articles over several years as the consumer can have the packaging articles over a long time before return thereof.

A safeguard against forgery is ensured by the selection of a suitably large set of numbers which is preferably 10 millions (10⁷) times larger than the numbers actually used. This means that the chance of being able to produce a correct number by fraud is also 1 to 10 millions for each packaging article. That gives a deposit number to be represented from the range of 10¹⁸.

There are many different possible ways of representing the deposit number. The representation of the information depends on the area required and the legibility involved in the deposit-removal operation. Some alternative configurations will be set forth by way of example here.

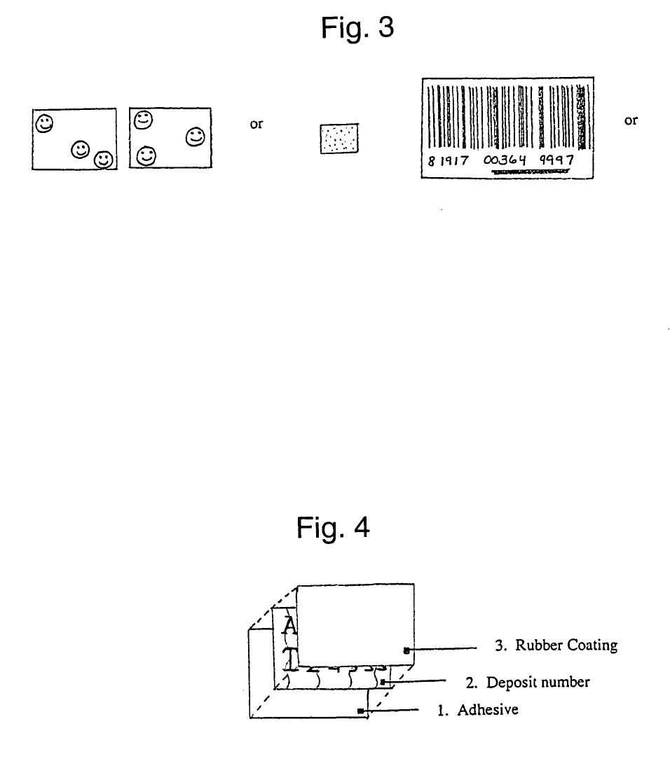

The representation of the deposit number can be represented as a numerical FIGURE by 18 digits, for example 428912592927402856. Combing numerical and alphabetical characters means that the deposit number can be represented as a 12-character alphanumeric number, for example A2ED5GTZ45BB or in the form of mutually separately arranged character groups ADED, 5GTZ, 45BB. Alternatively the deposit identification can also be represented graphically with the same level of security in various ways as shown in FIG. 3, for example with smileys.

The size of the deposit number is preferably in the range between ¼ cm² and 4 cm² in area. Depending on the respective choice of the representation other sizes are also a possibility, depending on the packaging article.

The deposit numbers can be applied in various ways. Basically, this is possible with the labelling systems which are already involved in the filling processes. For that purpose, the deposit number is applied similarly to a variable batch number or like the best-before date. The corresponding deposit numbers are electronically transmitted from the deposit database to the filling organisation. They cannot be guessed by virtue of the large set of numbers for the filling organisation. Deposit numbers which are used in duplicate are detected by means of the fraud management procedures and can be proven by impounding the packaging articles.

The deposit numbers can also be supplied by the deposit database in the form of stickers. That improves the uniformity and legibility of the deposit numbers. Visibility and in particular recognition of the deposit numbers by the consumer also affords a higher level of acceptance. In addition the supply of stickers produced by the system affords possible ways of detecting forgery on the material and thus improving fraud management.

Finally it is also possible for the deposit number to be printed on a carrier provided separately from the article, in the manner of a token, which the purchaser receives together with the packaging article and which he must give back when returning the article or the disposable packaging article. In that case however redemption of the deposit is actually only possible when a packaging article corresponding to the value of the token is returned. Accordingly, in this alternative embodiment, return is not limited to the individual packaging article but to a class of articles.

In a further development it can be provided that the consumer upon making the purchase can see that there is a deposit on a packaging article. The deposit number can be concealed for example under a seal. The deposit can be redeemed only when the seal has been removed and thus destroyed. Conversely, an undamaged seal means that the packaging article has not yet had the deposit redeemed thereon. The seal thus serves as an originality seal. The structure of such a seal is shown in FIG. 4.

Layer 1 of the seal is an adhesive which firmly joins the sticker to the packaging article. In contrast to reusable labels the adhesive is preferably not water-soluble.

Layer 2 is a paper which is cut into or a film or sheet on which the deposit number is printed. This means that the deposit number cannot be detached from the packaging article without involving destruction.

Layer 3 is a seal film or sheet or rubber coating which covers the deposit number and which allows the deposit number to be visible only after having been rubbed or scratched off.

Accordingly the invention also concerns an originality seal on which, at each stage in the method, it is directly possible for a consumer to see whether deposit removal has taken place as the seal is destroyed when that happens. The third layer does not necessarily have to be in the form of a rubber coating. The change in condition of the seal could also be effected by a change in color or other irreversible alterations.

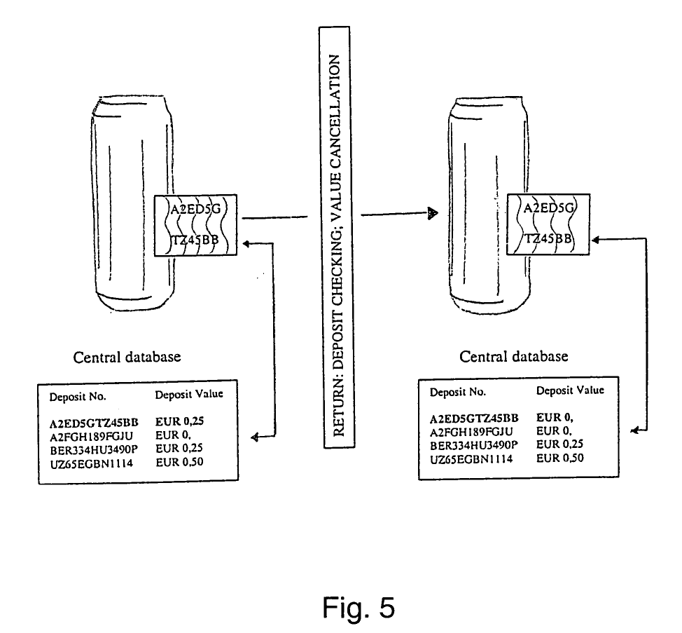

The system for deposit removal is shown in FIG. 5. When the consumer returns the packaging article to the shop the deposit number is transmitted to the database with the deposit numbers and stored as cancelled. The deposit number is admittedly still on the empty packaging article but it no longer has any deposit value. From that moment in time the empty packaging articles can be logistically easily collected and disposed of. The deposit number identified in the database excludes a deposit being paid back again for the packaging article.

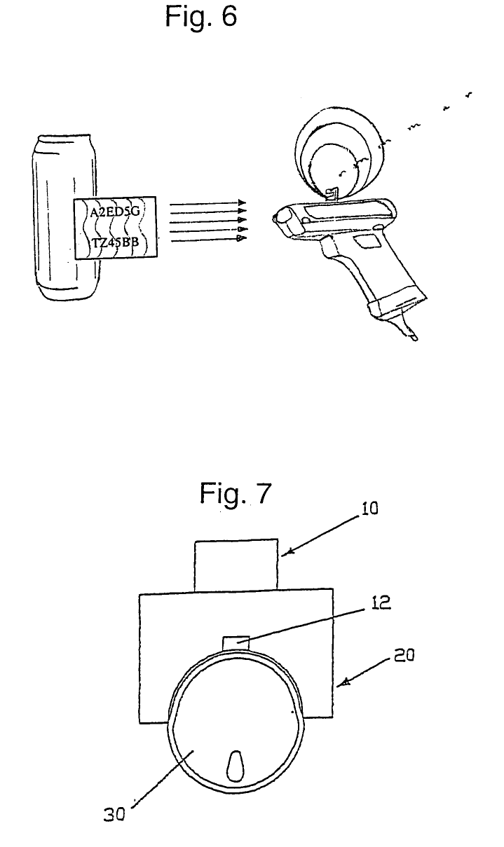

The operation of recognising the deposit number can be effected in particular in a store for example by a mobile or a stationary recognition system. The mobile deposit scanner shown in FIG. 6 in the form of a detection unit is a small light hand device which can be used at kiosks, funfairs, leisure parks and so forth. The scanner has a recognition unit with which the deposit numbers can be read off the packaging articles, and a data transfer unit. Data transfer can be by cable or by radio. The design configuration involving a bidirectionally operational Bluetooth radio interface is particularly compact. Bluetooth is the wireless connection of various communication devices. A line-of-sight connection between the terminals is no longer required by virtue of the radio transmission procedure. If deposit numbers with images are used an image recognition unit can also be provided in the scanner.

The data received by the scanner are communicated to the deposit database for example by way of data networks. In this respect there are various intermediate stations in which the data are collected and passed on. One or more scanners can communicate with a base station (this can be a cellular radio tower or a desktop device). The base station then forms the communication with the deposit database. This can be line oriented (ISDN, PSTN, GSM or the like) or packet oriented (IP, GPRS or the like).

From the deposit database the acknowledgement about the redeemed deposit is sent back to the deposit scanner so that, after the complete return of all packaging articles, the entire deposit amount can be read off at the scanner. To conclude the return procedure, the hand scanner prints out a receipt document for the consumer.

On the basis of the mobile deposit scanner, it is possible to provide self-service stations which can be used as return apparatuses in a store, for example in the form of a deposit scanner involving simple wall mounting. The consumer there redeems his deposit from his packaging articles and then throws them into a container.

In order to prevent the consumer from prematurely cancelling the deposit on full packaging articles, a mechanism checks the discarding of a packaging article before the amount of the deposit is credited. In order to prevent immediate cancellation of the deposit on new packaging articles prior to use thereof, the receiving device of the station can be so designed that it non-removably receives the article and optionally counts it.

So that the deposit redemption procedure is of a simple nature from the point of view of a store the deposit can be cashlessly credited to the consumer. For that purpose the consumer identifies himself in relation to the system. The deposit is then credited for example to his bank account or to his telephone bill.

As an additional incentive for consumers and stores it is further possible, depending on the place at which the packaging articles are returned, to implement the respective bonus system on the market (Payback®, Miles and More®, Webmiles® etc). Besides the redemption of the deposit the customer can then also collect discount points.

The first deposit redemption operation can be implemented in about 20 seconds: subsequent transactions then require in the region of 1-2 seconds. That is afforded by virtue of the fact that the system is in the form of an online system in which establishing the connection to the deposit database generally takes more time than the actual transaction process. At locations involving numerous deposit returns however the time for making the connection can almost disappear as all transactions are assessed as subsequent transactions.

The transaction costs for deposit redemption are at the present time about 1.25 cents of a Euro.

In a further development it can be provided that the deposit number can additionally be compared to other databases. That can afford for example an additional incentive, insofar as for example each millionth deposit is rewarded with a prize.

It will be apparent to the man skilled in the art that the deposit system according to the invention can be used not only for disposable packaging articles but also for other articles, for which well-ordered return is to be ensured, for example for batteries, dangerous chemicals or the like.

FIG. 7 shows a detection unit which is in the form of a hand scanner and which is provided with a receiving device 20 according to the invention, as a plan view. The receiving device 20 is of a substantially bridge-shaped configuration with a free space extending between two limbs, wherein the internal distance between the front ends of the limbs, that is to say the insertion opening for the packaging article, is slightly smaller than the outside diameter of the packaging article 30 to be detected. The reading unit 12 of the hand scanner is arranged at the apex of the bridge-shaped opening. Detection of the label of a can or the like is possible only when the can is slightly compressed and can be inserted into the insertion opening in order to move the label into the immediate region of the reading unit 12. Naturally this is only possible when the packaging article has been opened and emptied. Instead of a mobile hand scanner, the receiving device according to the invention can also be provided on stationary scanners. Existing scanners can be retro-fitted therewith.

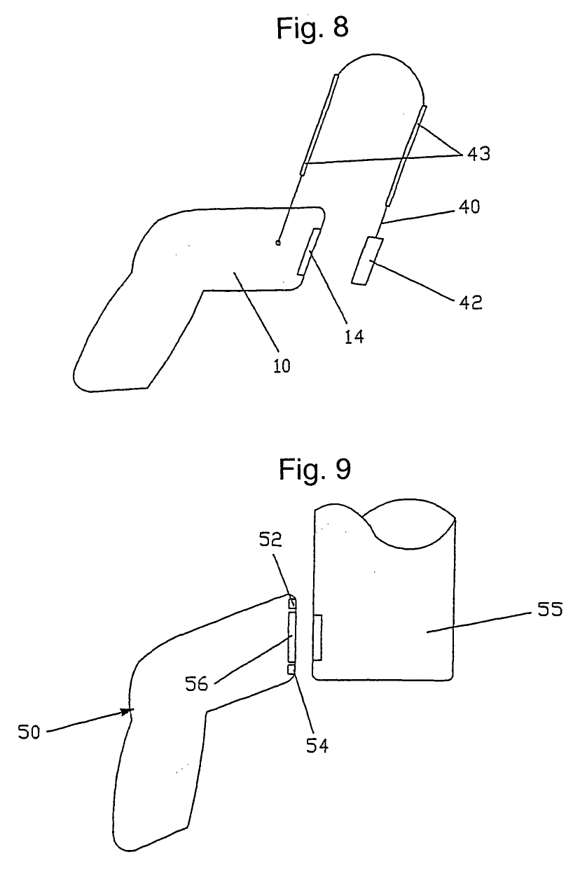

FIG. 8 shows a perspective view of a further embodiment of a detection unit which is also in the form of a hand scanner 10. Fixed on the top side of the scanner housing 10 is a U-shaped loop 40 which initially extends laterally away from the hand scanner 10 and after a 180°-curvature projects back in front of the reading unit 14 of the hand scanner 10. The end of the loop 40 is provided with a rectangular plate 42. As the plate 42 is arranged immediately in front of the reading unit, a packaging article from which the deposit is to be removed cannot be moved in a closed condition into the detection region of the reading unit 14. If in contrast the packaging article is empty, the free end of the loop 40 and the plate 42 can be inserted into the opening of the packaging article so that the label of the packaging article can be moved directly into the region of the reading unit 14, to cancel the deposit on the packaging article. The loop 40 is telescopic in the longitudinal portions 43.

FIG. 9 shows a perspective view of a further embodiment of a hand scanner 50 which operates not by means of optical detection means but by way of sound detection. For that purpose arranged at the front end of the hand scanner 50 at a spacing from each other are a lithotriptor 52 and a microphone 54. When a can from which the deposit is to be taken or another packaging article for deposit removal is arranged in front of the reading unit 56 of the hand scanner 50 the lithotriptor 52 emits a sound pulse which can be detected by the microphone 54. By way of the transit time delay for the sound in an empty can in comparison with a filled can, it is possible to establish whether the can is or is not empty. The deposit is redeemed only if the packaging article is actually empty.

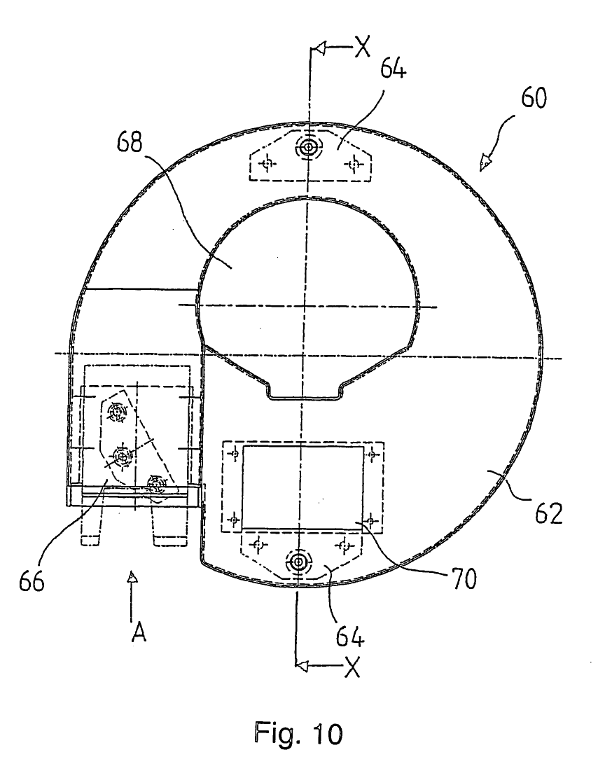

FIG. 10 shows a plan view on to the front side of a return device 60 according to the invention. It firstly comprises a substantially circular base plate 62 which for example can be made from a metal. On its side remote from the person viewing the drawing the base plate 62 is fixed at two fixing elements 64 arranged at the periphery of the base plate 62 to a collecting container 72 (not shown), for example a container for collecting disposable packaging articles. In the present case the fixing elements are in the form of substantially trapezoidal screw clamps. In a bottom left region of the return device 60, as viewed from the point of view of the person viewing the drawing, the circular shape is interrupted by a part of the circular arc having been removed. At one of the interruption points of the arc the base plate is continued straight tangentially with respect to the circular arc, wherein the resulting rectangular region rises from the base plate towards the viewer. That raised region accommodates a card reading unit 66 (shown in broken line) of the deposit-removal device, in which for example a code card can be inserted substantially in the direction A and can be used there for bringing into operation the deposit-removal device or as an auxiliary means in a settlement procedure. Arranged around the center point of the base plate 62 is a feed opening 68 of the return device 60, the center point of the base plate 62 not coinciding with the center of the feed opening 68 which is radially displaced. The feed opening 68 has a circular region, at the ends of which are arranged two straight leg-like portions which converge towards a trough-shaped portion joining the limbs. Overall the return device 60 is of a substantially annular configuration for the person viewing FIG. 10. When a user passes an article from which the deposit value is to be removed into the return device 60, he can observe it through a viewing window 70 which is arranged at the surface of the base plate and which is provided with a glass panel, and possibly re-align it, so that the article can be detected, identified and the deposit thereon redeemed.

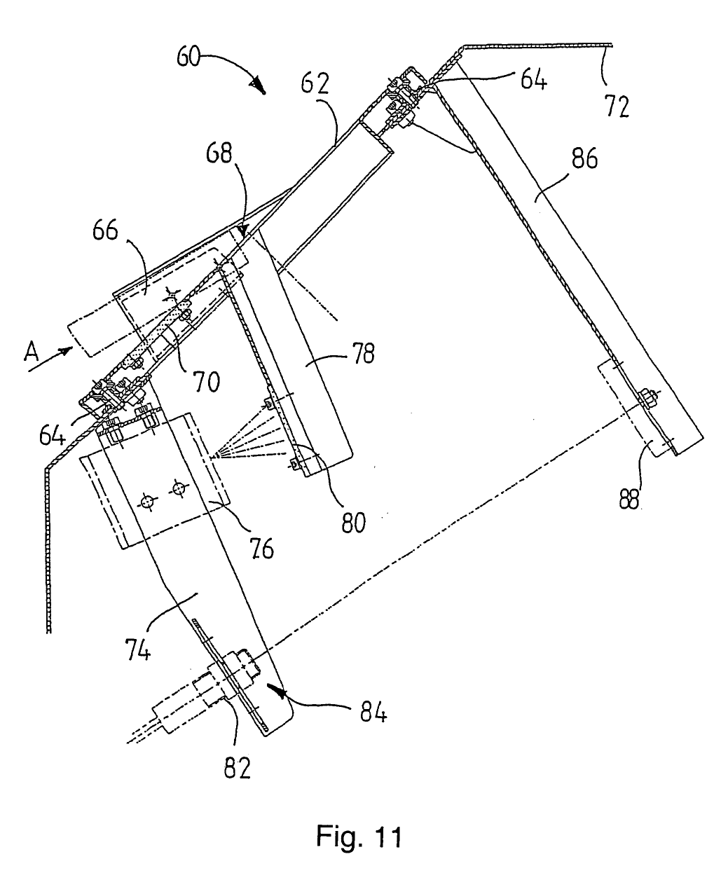

FIG. 11 shows a view in section through the return device 60 in FIG. 10 along line X-X. In this case the return device 60 is arranged on a collecting container 72 and covers over the receiving opening thereof. It is also possible clearly to see the region which is raised from the base plate 62 and which accommodates the card reading unit 66. A leg 74 extends from the edge region of the base plate 62, in the direction of the interior of the collecting container. Mounted to the leg 74 is a detection apparatus 76 which in the present case has a scanner. When an article from which the deposit is to be redeemed is pushed through the feed opening 68, it can be arranged in front of the detection apparatus 76 in such a way that the scanner can detect the identification disposed thereon, and identify it. To facilitate proper alignment of the article, the arrangement has a leg projecting also from the edge region of the base plate 62 into the interior of the container, acting as a guide rail 78; at its free end which is towards the interior of the container, in opposite relationship to the detection apparatus, the guide rail 78 has a viewing panel 80. By means of the guide rail 78 and the viewing panel 80 the article can be easily aligned in such a way that its identification can be detected by the beam from the scanner. The guide rail 78 thus serves as an orientation aid for aligning the article on which the deposit is to be redeemed, in order to reduce the number of translatory directions of movement and thus to permit simpler and correct alignment of the label in relation to the detection apparatus 76.

The deposit-removal operation which takes place in response to identification of the article is implemented by means of electronic components (not shown) which can be easily arranged (not shown) in the internal region of the return device. In this case, both the communication means for affording a communication with the database and also for example the voltage supply means are of a modular nature in such a fashion that, without involving major complication or expenditure, they can at any time be arranged on and removed again from the return device 60. Arranged further in the direction of the interior of the container, at a free end of the leg 74, is the lighting means 82 of a light barrier arrangement 84. The light thereof impinges on a reflector 88 arranged on a further, oppositely disposed leg 86 which projects into the interior of the container from the base plate 62. In this arrangement the deposit-removal operation for the article to be returned is such that a settlement procedure for the deposit value of the article is started only when the article has passed the light barrier arrangement 84. This therefore ensures that the article cannot be subsequently removed from the return device again and the claim for the deposit value is rightly made.

What is claimed is:

1. A computer-managed deposit system for articles, in particular disposable packaging articles, comprising the following method steps: associating the article with a unique identification from a plurality of identifications managed in a database thereby forming a linkage, associating the identification from the database with a deposit value, using the article in at least one intermediate step, detecting the identification of the article and identifying the article on the basis of the identification, and cancelling the linkage of the identification in the database when returning the deposit on the article.

2. A deposit system as set forth in claim 1 wherein in that the identification is arranged on the article on which a deposit is to be put.

3. A deposit system as set forth in claim 1 wherein the identification is printed on the article and applied to the article by a sticker.

4. A deposit system as set forth in claim 1 wherein the identification of the article is forgery-proof.

5. A deposit system as set forth in claim 1 wherein the deposit value of the article is refunded to a person handing in the article, in particular being credited in a cashless procedure.

6. A deposit system as set forth in claim 5 wherein, when the article is handed in, additional data which can be associated with the person are recorded and processed.

7. A deposit system as set forth in claim 1 wherein the identification of the article is linked with further items of information.

8. A deposit system as set forth in claim 1 wherein the article remains undamaged upon being handed in.

9. A return device for articles bearing a deposit, in particular for disposable packaging articles and in particular for use with the deposit system as set forth in claim 1, comprising a receiving device and at least one detection apparatus, wherein the detection apparatus detects an article arranged in the receiving device on the basis of an identification applied thereto and clearly identifies it.

10. A return device as set forth in claim 9 further comprising at the return device a deposit-removal device, by means of which the deposit can be redeemed from the article in a deposit-removal operation and a deposit value associated with the article can be passed to a settlement procedure.

11. A return device as set forth in claim 10 wherein the depositremoval device during the deposit-removal operation is at least temporarily in communication with at least one database in which the linkage of the identification is cancelled and in that way further use thereof is prevented.

12. A return device as set forth in claim 10 wherein the deposit-removal device has communication means, by way of which it makes a connection to a data processing apparatus with access to a database.

13. A return device as set forth in claim 9 wherein for positioning of the inserted article the receiving device has at least one guide means for proper alignment of the article.

14. A return device as set forth in claim 9 wherein the receiving device has a closure mechanism which is integrated or which can be arranged separately thereon.

15. A return device as set forth in claim 9 wherein detection means in the form of a light barrier arrangement and/or a scanner and/or a camera are provided at the detection apparatus.

16. A return device as set forth in claim 9 wherein that arranged at the return device is a display device, in particular a viewing window and/or an optical and/or acoustic signalling means and/or a display for imparting information to a user.

17. A return device as set forth in claim 9 wherein the return device can be arranged at a collecting container for the articles to be taken back.

18. A return device as set forth in claim 9 wherein the return device has a mains-independent or mains-supported voltage supply.

19. A return device as set forth in claim 9 wherein it has a user interface which permits a user an interaction with the return device, in particular implementation of a settlement procedure for redeeming the deposit value.

20. An originality seal for identifying an article, in particular a disposable packaging article and in particular for use in the deposit system as set forth in claim 1, comprising an adhesive layer for fixing to the article, a printable carrier layer which is arranged on the adhesive layer and which can be provided with an identification associated with the article, and a seal layer which at least partially covers over the carrier layer and which is only destructibly detachable from the carrier layer.

21. An originality seal as set forth in claim 20 wherein the adhesive layer is a non-removable adhesive.

22. An originality seal as set forth in claim 20 wherein that the carrier layer has at least one incision.

23. An originality seal as set forth in claim 20 wherein the identification includes a two-dimensional bar code.

24. An originality seal as set forth in claim 20 wherein the seal layer has an additional visual feature.

25. An originality seal as set forth in claim 20 wherein the seal layer comprises an adhesive, a wax or a rubber coating.

26. A detection unit, in particular for use with a deposit system as set forth in claim 1 for automatically detecting an identification of an article having a deposit thereon, in particular a scanner for detecting the identification of a disposable packaging article, having detection means for reading off the identification and means for ensuring that detection of the identification takes place only when the packaging article is emptied.

27. A detection unit as set forth in claim 26 wherein a receiving device for the packaging article, which is so dimensioned that the packaging article can be received therein only in the emptied condition.

28. A detection unit as set forth in claim 27 wherein the receiving device is of a substantially bridge-shaped configuration with a free space extending between two limbs, wherein the internal distance between the front ends of the limbs is slightly less than the outside diameter of the packaging article to be detected and the reading unit is arranged substantially at the apex of the bridge-shaped opening.

29. A detection unit as set forth in claim 28 wherein the internal distance between the limbs is adjustable.

30. A detection unit as set forth in claim 26 wherein a loop or the like which is so dimensioned that reading of the deposit mark is possible only when the loop is introduced into the opening of the packaging article from which the deposit is to be redeemed.

31. A detection unit as set forth in claim 30 wherein the loop is of a substantially U-shaped configuration.

32. A detection unit as set forth in claim 30 wherein the loop is adjustable in size.

33. A detection unit as set forth in claim 26 wherein it has a bar so positioned that reading of the deposit mark can be effected only when the bar passes through the packaging article.

34. A detection unit as set forth in claim 26 wherein sound-generating means for applying a sound pulse to the packaging article and
sound-detection means for detecting the sound pulse
